(19) United States
(12) Patent Application Publication
(10) Pub. No.: US 2007/0178307 A1
(43) Pub. Date: Aug. 2, 2007

(54) Use of core-shell particles

(76) Inventors: Holger Winkler, Darmstadt (DE); Peter Spahn, Hanau (DE); Goetz Peter Hellmann, Mainz (DE)

Correspondence Address: MILLEN, WHITE, ZELANO & BRANIGAN, P.C., 2200 CLARENDON BLVD., SUITE 1400, ARLINGTON, VA, 22201, US

(21) Appl. No.: 10/590,506

(22) PCT Filed: Feb. 7, 2005
(86) PCT No.: PCT/EP05/01209

§ 371 Date: Aug. 24, 2006

(30) Foreign Application Priority Data
Feb. 25, 2004 (DE) 10 2004 009 569.8

(51) Int. Cl. B32B 1/00

(52) U.S. Cl. 428/403

(57) ABSTRACT

The invention relates to the use of core/shell particles whose shell forms a matrix and whose core is essentially solid, is built up essentially from an inorganic material and has an essentially monodisperse size distribution and is connected to the shell via an interlayer, for the production of mouldings having homogeneous, regularly arranged cavities and particles in the cavities, to a process for the production of mouldings having homogeneous, regularly arranged cavities, and to the corresponding mouldings.

The invention relates to the use of core/shell particles for the production of mouldings having homogeneous, regularly arranged cavities and particles in the cavities, to a process for the production of such mouldings, and to the corresponding mouldings.

For the purposes of the present invention, mouldings having homogeneous, regularly arranged cavities are materials which have three-dimensional photonic structures. The term three-dimensional photonic structures is generally taken to mean systems which have a regular, three-dimensional modulation of the dielectric constants (and thus also of the refractive index). If the periodic modulation length corresponds approximately to the wavelength of (visible) light, the structure interacts with the light in the manner of a three-dimensional diffraction grating, which is evident from angle-dependent colour phenomena. An example of this is the naturally occurring precious stone opal, which consists of silicon dioxide spheres in spherical closest packing with air- or water-filled cavities in between. The inverse structure thereto is notionally formed by regular spherical cavities being arranged in closest packing in a solid material. An advantage of inverse structures of this type over the normal structures is the formation of photonic band gaps with much lower dielectric constant contrasts still (K. Busch et al. Phys. Rev. Letters E, 198, 50, 3896).

Three-dimensional inverse structures can be produced by template synthesis:
Monodisperse spheres are arranged in spherical closest packing as structure-forming templates.
The cavities between the spheres are filled with a gaseous or liquid pre-cursor or a solution of a precursor utilising capillary effects.
The precursor is converted (thermally) into the desired material.
The templates are removed, leaving behind the inverse structure.

Many such processes are disclosed in the literature. For example, SiO₂ spheres can be arranged in closest packing and the cavities filled with tetraethyl orthotitanate-containing solutions. After a number of conditioning steps, the spheres are removed using HF in an etching process, leaving behind the inverse structure of titanium dioxide (V. Colvin et al. Adv. Mater. 2001, 13, 180).

De La Rue et al. (De La Rue et al. Synth. Metals, 2001, 116, 469) describe the production of inverse opals consisting of TiO₂ by the following method: a dispersion of 400 nm polystyrene spheres is dried on a filter paper under an IR lamp. The filter cake is washed by sucking through ethanol, transferred into a glove box and infiltrated with tetraethyl orthotitanate by means of a water-jet pump. The filter paper is carefully removed from the latex/ethoxide composite, and the composite is transferred into a tubular furnace. Calcination in a stream of air is carried out in the tubular furnace at 575° C. for 8 hours, causing the formation of titanium dioxide from the ethoxide and burning out the latex particles. An inverse opal structure of TiO₂ remains behind.

Martinelli et al. (M. Martinelli et al. Optical Mater. 2001, 17, 11) describe the production of inverse TiO₂ opals using 780 nm and 3190 nm poly-styrene spheres. A regular arrangement in spherical closest packing is achieved by centrifuging the aqueous sphere dispersion at 700-1000 rpm for 24-48 hours followed by decantation and drying in air. The regularly arranged spheres are moistened with ethanol on a filter in a Buchner funnel and then provided dropwise with an ethanolic solution of tetraethyl orthotitanate. After the titanate solution has percolated in, the sample is dried in a vacuum desiccator for 4-12 hours. This filling procedure is repeated 4 to 5 times. The polystyrene spheres are subsequently burnt out at 600° C.-800° C. for 8-10 hours.

Stein et al. (A. Stein et al. Science, 1998, 281, 538) describe the synthesis of inverse TiO₂ opals starting from polystyrene spheres having a diameter of 470 nm as templates. These are produced in a 28-hour process, subjected to centrifugation and air-dried. The latex templates are then applied to a filter paper. Ethanol is sucked into the latex template via a Büchner funnel connected to a vacuum pump. Tetraethyl orthotitanate is then added dropwise with suction. After drying in a vacuum desiccator for 24 hours, the lattices are burnt out at 575° C. for 12 hours in a stream of air.

Vos et al. (W. L. Vos et al. Science, 1998, 281, 802) produce inverse TiO₂ opals using polystyrene spheres having diameters of 180-1460 nm as templates. In order to establish spherical closest packing of the spheres, a sedimentation technique is used supported by centrifugation over a period of up to 48 hours. After slow evacuation in order to dry the template structure, an ethanolic solution of tetra-n-propoxy orthotitanate is added to the latter in a glove box. After about 1 hour, the infiltrated material is brought into the air in order to allow the precursor to react to give TiO₂. This procedure is repeated eight times in order to ensure complete filling with TiO₂. The material is then calcined at 450° C.

The production of photonic structures from inverse opals is very complex and time-consuming by the processes described in the literature:
lengthy/complex production of the template or the arrangement of the spheres forming the template-forming structure in spherical closest packing
filling of the cavities of the template structure with precursors, which is lengthy/complex since it frequently has to be carried out a number of times
lengthy/complex procedure for removal of the templates
only limited or no possibility of the production of relatively large photonic structures having an inverse opal structure and scale-up of the laboratory synthesis into industrial production.

The disadvantages make the production of the desired photonic materials having an inverse opal structure more difficult.

Easily implemented processes for the production of photonic materials having an inverse opal structure which can also be transferred to an industrial scale are disclosed by the following specifications: The use of core/shell particles whose shell forms a matrix and whose core is essentially solid and has an essentially monodisperse size distribution and is connected to the shell via an interlayer and whose shell has thermoplastic properties, for the production of mouldings having homogeneous, regularly arranged cavities is described in the earlier German patent application with the application number DE 10357680.0. Corresponding core/shell particles whose shell forms a matrix and whose core is essentially solid and has an essentially monodisperse size distribution are described in German patent application DE-A-10145450. The use of core/shell particles whose shell forms a matrix and whose core is essentially solid and has an essentially monodisperse size distribution as templates for the production of inverse opal structures and a process for the production of inverse opal-like structures using core/shell particles of this type are described in the earlier German patent application DE 10245848.0. The mouldings described having homogeneous, regularly arranged cavities (i.e. inverse opal structure) preferably have walls of metal oxides or of elastomers. Consequently, the mouldings described are either hard and brittle or exhibit an elastomeric character with low mechanical loadability. In the earlier German patent application with the application number DE 10357680.0, it was found that the use of core/shell particles whose shell has thermoplastic properties results in mouldings having homogeneous, regularly arranged cavities whose mechanical properties are particularly advantageous.

Inverse structures containing nanoparticles are disclosed, for example, in J. C. Kim, Y. N. Kim, E. O. Chi, N. H. Hur, S. B. Yoon, J.-S. Yu, J. Mater. Res. 18(4), 2003, pp. 780-783. The formation of titanium dioxide nanoparticles in an inverse carbon matrix is described here.

However, an easily implemented process for the production of mouldings of this type having homogeneous, regularly arranged cavities and particles in the cavities which can also be transferred to an industrial scale has not been disclosed to date.

Surprisingly, it has now been found that it is possible to obtain mouldings of this type having homogeneous, regularly arranged cavities and particles in the cavities in a simple manner if core/shell particles which are suitable for their production are employed.

The present invention therefore relates firstly to the use of core/shell particles whose shell forms a matrix and whose core is essentially solid, is built up essentially from an inorganic material and has an essentially mono-disperse size distribution and is connected to the shell via an interlayer, for the production of mouldings having homogeneous, regularly arranged cavities and particles in the cavities.

The present invention furthermore relates to a process for the production of mouldings having homogeneous, regularly arranged cavities and particles in the cavities, characterised in that
a) core/shell particles whose core is essentially solid, is built up essentially from an inorganic material and has an essentially monodisperse size distribution and is connected to the shell via an interlayer, are converted into mouldings, preferably films, with application of a mechanical force and elevated temperature,
b) one or more precursors of suitable wall materials are added,
c) and the shell material is subsequently removed.

The use according to the invention of core/shell particles results, in particular, in the following advantages:
on drying of the dispersions of core/shell particles, cracking in the template (=arrangement of the spheres) during drying can be reduced or even prevented entirely,
large-area regions of high order can be obtained in the template,
stresses which arise during the drying process can be compensated for by the elastic nature of the shell,
if polymers form the shell, these can intertwine with one another and thus mechanically stabilise the regular sphere arrangement in the template,
since the shell is strongly bonded to the core—preferably by grafting—via an interlayer, the templates can be processed via melt processes.

The present invention furthermore also relates to the products obtainable with the use according to the invention. Also claimed are therefore mouldings having homogeneous, regularly arranged cavities, which are characterised in that the regularly arranged cavities essentially each contain one particle.

Particular preference is given here in accordance with the invention to mouldings in which the particles present in the cavities consist of an electrically and/or magnetically conductive material or have an electrically and/or magnetically conductive layer or have an electrically and/or magnetically conductive core, where the electrically and/or magnetically conductive material is preferably a metal or magnetite. Mouldings of this type have the particular advantage that their optical properties can be switched electrically or magnetically.

As depicted in FIG. 2, the core particles in the uninfluenced state are present in the mouldings within the cavities in any desired orientations to the cavity wall (FIG. 2a). Mouldings of this type appear as white solids. If the core particles in the cavities are uniformly aligned by application of an electric and/or magnetic field (FIG. 2b), a regular crystal lattice forms, which exhibits opal-like effects, depending on the periodicity.

In this preferred variant of the invention, it is in turn preferred for the core of the core/shell particles used to consist of an electrically and/or magnetically conductive material or to have an electrically and/or magnetically conductive layer or to have an electrically and/or magnetically conductive core, where the electrically and/or magnetically conductive material is preferably a metal or magnetite.

The wall or matrix of the mouldings obtainable in accordance with the invention is formed from an inorganic material, preferably a metal chalcogenide or metal pnictide. In the present description, this material is referred to as wall material. For the purposes of the present invention, the term chalcogenides is applied to compounds in which an element from group 16 of the Periodic Table is the electronegative bonding partner; the term pnictides is applied to those in which an element from group 15 of the Periodic Table is the electronegative bonding partner. Preferred wall materials are metal chalcogenides, preferably metal oxides, or metal pnictides, preferably nitrides or phosphides. For the purposes of these terms, the term metal is taken to mean all elements which can occur as electropositive partner compared with the counterions, such as the classical metals from the sub-groups, such as, in particular, titanium and zirconium, or the main-group metals from the first and second main groups, but equally well all elements from the third main group, as well as silicon, germanium, tin, lead, phosphorus, arsenic, antimony and bismuth. Preferred metal chalcogenides include, in particular, silicon dioxide, titanium dioxide and/or aluminium oxide.

The starting material (precursor) employed for the production of inverse opals in accordance with this variant of the invention can in principle be all conceivable precursors which are liquid, sinterable or soluble and which can be converted into stable solids by a sol-gel-analogous conversion. Sinterable precursors here are taken to mean ceramic or pre-ceramic particles, preferably nanoparticles, which can be converted into a moulding—the inverse opal—by—as usual in ceramics—sintering, if desired with elimination of readily volatile by-products. The relevant ceramic literature (for example H. P. Baldus, M. Jansen, Angew. Chem. 1997, 109, 338-354) discloses precursors of this type to the person skilled in the art. Gaseous precursors, which can be infiltrated into the template structure by a CVD-analogous method known per se, can furthermore also be employed. In a preferred variant of the present invention, use is made of solutions of one or more esters of a corresponding inorganic acid with a lower alcohol, such as, for example, tetraethoxysilane, tetrabutoxytitanium, tetrapropoxyzirconium or mixtures thereof.

In order to achieve the optical or photonic effect according to the invention described above, it is desirable for the core/shell particles to have a mean particle diameter in the range from about 5 nm to about 2000 nm. It may be particularly preferred here for the core/shell particles to have a mean particle diameter in the range from about 5 to 20 nm, preferably from 5 to 10 nm. In this case, the cores may be known as “quantum dots”; they exhibit the corresponding effects known from the literature. In order to achieve colour effects in the region of visible light, it is particularly advantageous or the core/shell particles to have a mean particle diameter in the range about 50-800 nm. Particular preference is given to the use of particles in the range 100-600 nm and very particularly preferably in the range from 200 to 450 nm since in particles in this size range (depending on the refractive-index contrast which can be achieved in the photonic structure), the reflections of various wavelengths of visible light differ significantly from one another, and thus the opalescence which is particularly important for optical effects in the visible region occurs to a particularly pronounced extent in a very wide variety of colours. However, it is also preferred in a variant of the present invention to employ multiples of this preferred particle size, which then result in reflections corresponding to the higher orders and thus in a broad colour play.

The cavities of the mouldings according to the invention then in each case have corresponding mean diameters which are approximately identical to the diameters of the cores. The cavity diameter thus corresponds to about ⅔ of the core/shell particle diameter for preferred core/shell ratios of the particles. It is particularly preferred in accordance with the invention for the mean diameter of the cavities to be in the range about 50-500 nm, preferably in the range 100-500 nm and very particularly preferably in the range from 200 to 280 nm.

It is furthermore preferred in accordance with the invention for the core of the core/shell particles to consist of a material which is either not flowable or becomes flowable at a temperature above the melting point of the shell material. This can be achieved through the use of inorganic core materials. The suitable materials are described below in detail.

It is furthermore particularly preferred in a variant of the invention for the cores to be built up from a metal or semimetal or a metal chalcogenide or metal pnictide. For the purposes of the present invention, the term chalcogenides is applied to compounds in which an element from group 16 of the Periodic Table is the electronegative bonding partner; the term pnictides is applied to those in which an element from group 15 of the Periodic Table is the electronegative bonding partner. Preferred cores consist of metal chalcogenides, preferably metal oxides, or metal pnictides, preferably nitrides or phosphides. For the purposes of these terms, the term metal is taken to mean all elements which can occur as electropositive partner compared with the counterions, such as the classical metals from the sub-groups, or the main-group metals from the first and second main groups, but equally well all elements from the third main group, as well as silicon, germanium, tin, lead, phosphorus, arsenic, antimony and bismuth. Preferred metal chalcogenides and metal pnictides include, in particular, silicon dioxide, titanium dioxide, aluminium oxide, gallium nitride, boron nitride, aluminium nitride, silicon nitride and phosphorus nitride.

In a variant of the present invention, the starting material employed for the production of the core/shell particles to be employed in accordance with the invention preferably comprises monodisperse cores of silicon dioxide, which can be obtained, for example, by the process described in U.S. Pat. No. 4,911,903. The cores here are produced by hydrolytic polycondensation of tetraalkoxysilanes in an aqueous/ammoniacal medium, where firstly a sol of primary particles is produced, and the resultant SiO₂ particles are subsequently converted to the desired particle size by continuous, controlled, metered addition of tetraalkoxysilane. This process enables the production of monodisperse SiO₂ cores having mean particle diameters of between 0.05 and 10 μm with a standard deviation of 5%.

Another starting material which can be employed comprises monodisperse cores of non-absorbent metal oxides, such as TiO₂, ZrO₂, ZnO₂, SnO₂ or Al₂O₃, or metal-oxide mixtures. Their production is described, for example, in EP 0 644 914. Furthermore, the process described in EP 0 216 278 for the production of monodisperse SiO₂ cores can be applied readily and with the same result to other oxides. Tetraethoxysilane, tetrabutoxytitanium, tetrapropoxyzirconium or mixtures thereof are added in one portion with vigorous mixing to a mixture of alcohol, water and ammonia, whose temperature is set precisely to from 30 to 40° C. by means of a thermostat, and the resultant mixture is stirred vigorously for a further 20 seconds, during which a suspension of monodisperse cores in the nanometre range forms. After a post-reaction time of from 1 to 2 hours, the cores are separated off in a conventional manner, for example by centrifugation, washed and dried.

The optional coating of the particles with magnetite can be carried out by precipitation from a solution of iron(II) and iron(III) salts, preferably from a solution of iron(II) and iron(III) sulfate. The molar ratio between the divalent and trivalent iron salt is preferably about 1:1. It must be noted that the precipitation solutions must be protected against oxidation, but the presence of oxidants or reducing agents during the precipitation is not necessary. The pH for the precipitation of magnetic Fe₃O₄ (magnetite) is set to values between 7 and 9, preferably between 7.5 and 8.5. The pH is kept constant during the precipitation reaction by addition of a base, use preferably being made of 25% aqueous ammonia solution. The temperature of the suspension is set to from 0 to 40° C. The metering rate of the iron(II)/iron(III) salt solution is typically between 0.05 and 3 mg of Fe₃O₄ per minute and per m² of surface, preferably between 0.2 and 1 mg of Fe₃O₄ per minute and per m² of surface of the particles. Under the stated conditions, the magnetite is deposited on the surface of the particles, with the size of the magnetite particles forming being up to 60 nm by this method. A further coating of the magnetic particles with SiO₂ which is advantageous for subsequent surface functionalisation can be carried out by hydrolysis of tetraalkylorthosilanes, preferably tetraethylorthosilane. For this purpose, the suspension of the magnetite-coated particles is adjusted to a temperature of from 0 to 40° C., preferably from 10 to 30° C., and an aqueous, acetic-acid solution of tetraethylorthosilane is metered in at a pH of from 7 to 9, preferably from 7.5 to 8.5. The concentration of the silane in the solution is from 10 to 50, preferably from 20 to 40 g of SiO₂/l. The metering rate is set to from 0.1 to 5 mg of SiO₂ per minute and per m² of surface of the uncoated particles, preferably from 1 to 2 g of SiO₂ per minute and per m² of surface. After completion of the metered addition, the suspension is warmed to from 60 to 90° C., preferably from 70 to 80° C., and the pH is raised to from 8 to 10 over the course of 30 minutes using 25% ammonia solution, and the suspension is kept at this temperature and at this pH for 30 minutes. After cooling to room temperature, the SiO₂-coated magnetic particles are separated off and washed with deionised water until salt-free. They are subsequently redispersed in deionised water.

Preferred magnetic particles to be employed in accordance with the invention as cores consist of an SiO₂ core coated with from 5 to 60% by weight, preferably from 20 to 40% by weight, of magnetite, based on the SiO₂ core, and an SiO₂ post-coating of from 5 to 30% by weight, preferably from 10 to 20% by weight, of SiO₂, based on the SiO₂ core.

In a preferred embodiment of the invention, the interlayer is a layer of crosslinked or at least partially crosslinked polymers. The crosslinking of the interlayer here can take place via free radicals, for example induced by UV irradiation, or preferably via di- or oligofunctional monomers. Preferred interlayers in this embodiment comprise from 0.01 to 100% by weight, particularly preferably from 0.25 to 10% by weight, of di- or oligofunctional monomers. Preferred di- or oligofunctional monomers are, in particular, isoprene and allyl methacrylate (ALMA). Such an interlayer of crosslinked or at least partially crosslinked polymers preferably has a thickness in the range from 10 to 20 nm. If the interlayer comes out thicker, the refractive index of the layer is selected so that it corresponds either to the refractive index of the core or to the refractive index of the shell.

If copolymers which, as described above, contain a crosslinkable monomer are employed as interlayer, the person skilled in the art will have absolutely no problems in suitably selecting corresponding copolymerisable monomers. For example, corresponding copolymerisable monomers can be selected from a so-called Q-e-scheme (cf. textbooks on macro-molecular chemistry). Thus, monomers such as methyl methacrylate and methyl acrylate can preferably be polymerised with ALMA.

In another, likewise preferred embodiment of the present invention, shell polymers are grafted directly onto the core via a corresponding functionalisation of the core. The surface functionalisation of the core here forms the interlayer according to the invention.

The type of surface functionalisation here depends principally on the material of the core. Silicon dioxide surfaces can, for example, advantageously be suitably modified with silanes carrying correspondingly reactive end groups, such as epoxy functions or free double bonds. The mono-disperse cores are dispersed in alcohols and modified with common organoalkoxysilanes. The silanisation of spherical oxide particles is also described in DE 43 16 814.

Silanisation of this type improves the dispersibility of inorganic cores and thus simplifies, in particular, the polymerisation-on of the interlayer polymers by emulsion polymerisation. Growing-on of the shell polymers can also be achieved directly via this functionalisation, i.e. the silane modification then serves as interlayer.

In a preferred embodiment, the shell of these core/shell particles consists of essentially uncrosslinked organic polymers, which are preferably grafted onto the core via an at least partially crosslinked interlayer. The only essential factor for the purposes of the present invention is that the shell can be removed under conditions under which the wall material and the core are stable, for example by firing. The choice of suitable core/shell/interlayer/wall material combinations presents the person skilled in the art with absolutely no difficulties.

Owing to the considerations mentioned here, it is advantageous for the shell of the core/shell particles according to the invention to comprise one or more polymers and/or copolymers or polymer precursors and, if desired, auxiliaries and additives, where the composition of the shell may be selected in such a way that it is essentially dimensionally stable and tack-free in a non-swelling environment at room temperature.

With the use of polymer substances as shell material, the person skilled in the art gains the freedom to determine their relevant properties, such as, for example, their composition, the particle size, the mechanical data, the glass transition temperature, the melting point and the core:shell weight ratio and thus also the applicational properties of the core/shell particles. In principle, all polymers of the classes already mentioned above, if they are selected or built up in such a way that they conform to the specification given above for the shell polymers, are suitable for the shell material. Polymers which meet the specifications for a shell material are likewise present in the groups of polymers and copolymers of polymerisable un-saturated monomers and polycondensates and copolycondensates of monomers containing at least two reactive groups, such as, for example, high-molecular-weight aliphatic, aliphatic/aromatic or fully aromatic poly-esters and polyamides. Taking into account the above conditions for the properties of the shell polymers (=matrix polymers), selected units from all groups of organic film formers are in principle suitable for their preparation. Some further examples are intended to illustrate the broad range of polymers which are suitable for the production of the shells. Suitable shell polymers are, for example, polymers such as polyacrylates, polymethacrylates, polybutadiene, polymethyl methacrylate, polyesters, polyamides and polyacrylonitrile. Likewise suitable for the shell are, for example, polymers having a preferably aromatic basic structure, such as polystyrene, polystyrene copolymers, such as, for example, SAN, aromatic-aliphatic polyesters and polyamides, aromatic polysulfones and polyketones, and also polyacrylonitrile.

With regard to the processing possibilities and in particular also the possibility of building up the matrix walls, it is preferred in accordance with the invention for the core in the core/shell particles to make up from 10⁻⁵% by vol. to about 75% by vol. of the core/shell particle volume, preferably from 10⁻⁴% by vol. to 60% by vol. and particularly preferably from about 10⁻³% by vol. to about 50% by vol. of the core/shell particle volume.

Correspondingly, the shell material selected can preferably be organic polymers, such as, for example, poly(styrene), poly(acrylate) derivatives, particularly preferably poly(methyl methacrylate) or poly(cyclohexyl methacrylate), or copolymers of these polymers with other acrylates, such as, preferably, styrene-acrylonitrile copolymers, styrene-ethyl acrylate copolymers or methyl methacrylate-ethyl acrylate copolymers.

In another preferred embodiment of the present invention, the shell in the core/shell particles is essentially built up from a UV radiation-degradable material, preferably a UV-degradable organic polymer and particularly preferably from poly(tert-butyl methacrylate), poly(methyl methacrylate), poly(n-butyl methacrylate) or copolymers containing one of these polymers.

The production of corresponding core/shell particles is known from the literature and is described, for example, in detail in international patent application WO 2003025035, whose disclosure content in this respect expressly also belongs to the disclosure content of the present application.

A preferred way of obtaining the particles is a process for the production of core/shell particles by a) surface treatment of monodisperse cores, and b) application of the shell of organic polymers to the treated cores.

In a preferred process variant, a crosslinked polymeric interlayer, which preferably contains reactive centres to which the shell can be covalently bonded, is applied to the cores, preferably by emulsion polymerisation or by ATR polymerisation. ATR polymerisation here stands for atom transfer radical polymerisation, as described, for example, in K. Matyjaszewski, Practical Atom Transfer Radical Polymerisation, Polym. Mater. Sci. Eng. 2001, 84. The encapsulation of inorganic materials by means of ATRP is described, for example, in T. Werne, T. E. Patten, Atom Transfer Radical Polymerisation from Nanoparticles: A Tool for the Preparation of Well-Defined Hybrid Nanostructures and for Understanding the Chemistry of Controlled/“Living” Radical Polymerisation from Surfaces, J. Am. Chem. Soc. 2001, 123, 7497-7505 and WO 00/11043. The performance both of this method and of emulsion polymerisations is familiar to the person skilled in the art of polymer preparation and is described, for example, in the above-mentioned literature references.

The liquid reaction medium in which the polymerisations or copolymerisations can be carried out consists of the solvents, dispersion media or diluents usually employed in polymerisations, in particular in emulsion polymerisation processes. The choice here is made in such a way that the emulsifiers employed for homogenisation of the core particles and shell precursors are able to develop adequate efficacy. Suitable liquid reaction media for carrying out the process according to the invention are aqueous media, in particular water.

Suitable for initiation of the polymerisation are, for example, polymerisation initiators which decompose either thermally or photochemically, form free radicals and thus initiate the polymerisation. Preferred thermally activatable polymerisation initiators here are those which decompose at between 20 and 180° C., in particular at between 20 and 80° C. Particularly preferred polymerisation initiators are peroxides, such as dibenzoyl peroxide, di-tert-butyl peroxide, peresters, percarbonates, perketals, hydroperoxides, but also inorganic peroxides, such as H₂O₂, salts of peroxosulfuric acid and peroxodisulfuric acid, azo compounds, alkylboron compounds, and hydrocarbons which decompose homolytically. The initiators and/or photoinitiators, which, depending on the requirements of the polymerised material, are employed in amounts of between 0.01 and 15% by weight, based on the polymerisable components, can be used individually or, in order to utilise advantageous synergistic effects, in combination with one another. In addition, use is made of redox systems, such as, for example, salts of peroxodisulfuric acid and peroxosulfuric acid in combination with low-valency sulfur compounds, particularly ammonium peroxodisulfate in combination with sodium dithionite.

Corresponding processes have also been described for the production of polycondensation products. Thus, it is possible for the starting materials for the production of polycondensation products to be dispersed in inert liquids and condensed, preferably with removal of low-molecular-weight reaction products, such as water or—for example on use of di(lower alkyl) dicarboxylates for the preparation of polyesters or polyamides—lower alkanols.

Polyaddition products are obtained analogously by reaction of compounds which contain at least two, preferably three, reactive groups, such as, for example, epoxide, cyanate, isocyanate or isothiocyanate groups, with compounds carrying complementary reactive groups. Thus, isocyanates react, for example, with alcohols to give urethanes and with amines to give urea derivatives, while epoxides react with these complementary groups to give hydroxyethers and hydroxyamines respectively. Like the polycondensations, polyaddition reactions can also advantageously be carried out in an inert solvent or dispersion medium.

The stable dispersions required for these polymerisation, polycondensation or polyaddition processes are generally prepared using dispersion auxiliaries.

The dispersion auxiliaries used are preferably water-soluble, high-molecular-weight organic compounds containing polar groups, such as poly-vinylpyrrolidone, copolymers of vinyl propionate or acetate and vinyl-pyrrolidone, partially saponified copolymers of an acrylate and acrylonitrile, polyvinyl alcohols having different residual acetate contents, cellulose ethers, gelatine, block copolymers, modified starch, low-molecular-weight polymers containing carboxyl and/or sulfonyl groups, or mixtures of these substances.

Particularly preferred protective colloids are polyvinyl alcohols having a residual acetate content of less than 35 mol %, in particular from 5 to 39 mol %, and/or vinylpyrrolidone-vinyl propionate copolymers having a vinyl ester content of less than 35% by weight, in particular from 5 to 30% by weight.

It is possible to use nonionic or ionic emulsifiers, if desired also as a mixture. Preferred emulsifiers are optionally ethoxylated or propoxylated, relatively long-chain alkanols or alkylphenols having different degrees of ethoxylation or propoxylation (for example adducts with from 0 to 50 mol of alkylene oxide) or neutralised, sulfated, sulfonated or phosphated derivatives thereof. Neutralised dialkylsulfosuccinic acid esters or alkyldiphenyl oxide disulfonates are also particularly suitable.

Particularly advantageous are combinations of these emulsifiers with the above-mentioned protective colloids, since particularly finely divided dispersions are obtained therewith.

Through the setting of the reaction conditions, such as temperature, pressure, reaction duration and use of suitable catalyst systems, which influence the degree of polymerisation in a known manner, and the choice of the monomers employed for their production—in terms of type and proportion—the desired property combinations of the requisite polymers can be set specifically. The particle size here can be set, for example, through the choice and amount of the initiators and other parameters, such as the reaction temperature. The corresponding setting of these parameters presents the person skilled in the art in the area of polymerisation with absolutely no difficulties.

In the process according to the invention for the production of a moulding having homogeneous, regularly arranged cavities, a “positive” opal structure is formed as template in a first step through the application of a mechanical force to the core/shell particles.

For the purposes of the present invention, the action of mechanical force can be the action of a force which occurs in the conventional processing steps of polymers. In preferred variants of the present invention, the action of mechanical force takes place either:
through uniaxial pressing or
action of force during an injection-moulding operation or
during a transfer moulding operation,
during (co)extrusion or
during a calendering operation or
during a blowing operation.

If the action of force takes place through uniaxial pressing, the mouldings according to the invention are preferably films. Films according to the invention can preferably also be produced by calendering, film blowing or flat-film extrusion. The various ways of processing polymers under the action of mechanical forces are well known to the person skilled in the art and are revealed, for example, by the standard textbook Adolf Franck, “Kunststoff-Kompendium” [Plastics Compendium]; Vogel-Verlag; 1996. The processing of core/shell particles through the action of mechanical force, as is preferred here, is furthermore described in detail in international patent application WO 2003025035.

It is particularly advantageous here for the application of a mechanical force to take place in step a2) to a mass of the core/shell particles predried in step a1).

In a preferred variant of the production of mouldings according to the invention, the temperature during production is at least 40° C., preferably at least 60° C., above the glass transition temperature of the shell of the core/shell particles. It has been shown empirically that the flowability of the shell in this temperature range meets the requirements for economic production of the mouldings to a particular extent.

In a likewise preferred process variant which results in mouldings according to the invention, the flowable core/shell particles are cooled under the action of the mechanical force to a temperature at which the shell is no longer flowable.

If mouldings are produced by injection moulding, it is particularly preferred for the demoulding not to take place until after the mould with the moulding inside has cooled. When carried out in industry, it is advantageous to employ moulds having a large cooling-channel cross section since the cooling can then take place in a relatively short time. It has been found that cooling in the mould makes the colour effects according to the invention much more intense. It is assumed that better ordering of the core/shell particles to form the lattice occurs in this uniform cooling operation. It is particularly advantageous here for the mould to have been heated before the injection operation.

The mouldings according to the invention may, if it is technically advantageous, comprise auxiliaries and additives here. They can serve for optimum setting of the applicational data or properties desired or necessary for application and processing. Examples of auxiliaries and/or additives of this type are antioxidants, UV stabilisers, biocides, plasticisers, film-formation auxiliaries, flow-control agents, fillers, melting assistants, adhesives, release agents, application auxiliaries, demoulding auxiliaries, viscosity modifiers, for example thickeners.

Particularly recommended are additions of film-formation auxiliaries and film modifiers based on compounds of the general formula HO−CₙH₂ₙ—O—(CₙH₂ₙ—O)ₘH, in which n is a number from 2 to 4, preferably 2 or 3, and m is a number from 0 to 500. The number n can vary within the chain, and the various chain members can be incorporated in a random or blockwise distribution. Examples of auxiliaries of this type are ethylene glycol, propylene glycol, di-, tri- and tetraethylene glycol, di-, tri- and tetrapropylene glycol, polyethylene oxides, polypropylene oxide and ethylene oxide-propylene oxide copolymers having molecular weights of up to about 15,000 and a random or block-like distribution of the ethylene oxide and propylene oxide units.

If desired, organic or inorganic solvents, dispersion media or diluents, which, for example, extend the open time of the formulation, i.e. the time available for its application to substrates, waxes or hot-melt adhesives are also possible as additives.

If desired, UV and weathering stabilisers can also be added to the mouldings. Suitable for this purpose are, for example, derivatives of 2,4-dihydroxybenzophenone, derivatives of 2-cyano-3,3′-diphenyl acrylate, derivatives of 2,2′,4,4′-tetrahydroxybenzophenone, derivatives of o-hydroxy-phenylbenzotriazole, salicylic acid esters, o-hydroxyphenyl-s-triazines or sterically hindered amines. These substances may likewise be employed individually or in the form of a mixture.

The total amount of auxiliaries and/or additives is up to 40% by weight, preferably up to 20% by weight, particularly preferably up to 5% by weight, of the weight of the mouldings.

A precursor of suitable wall materials is subsequently added to the template, as described above. In a preferred variant of the process according to the invention for the production of mouldings having regularly arranged cavities, the precursor is therefore a solution of an ester of an inorganic ortho-acid with a lower alcohol, preferably tetraethoxysilane, tetrabutoxytitanium, tetrapropoxyzirconium or mixtures thereof. Suitable solvents for the precursors are, in particular, lower alcohols, such as methanol, ethanol, n-propanol, isopropanol or n-butanol.

As has been shown, it is advantageous to allow the precursors to act on the template structure of core/shell particles for some time under a protective-gas blanket in order to effect uniform penetration into the cavities. For the same reason, it is advantageous for the precursors to be added to the template structure under reduced pressure, preferably in a static vacuum of p<1 mbar.

The formation of the wall material from the precursors is carried out either by addition of water and/or by heating the reaction batch. In the case of alkoxide precursors, heating in air is generally sufficient for this purpose. Under certain circumstances, it may be advantageous to wash the impregnated template briefly with a small amount of a solvent in order to wash off precursor adsorbed onto the surface. With this step, the formation of a thick layer of wall material, which can act as diffuser, on the surface of the template can be prevented. For the same reason, it may be advantageous also to dry the impregnated structure under mild conditions before the calcination.

The removal of the shell material in step c) can be carried out by various methods. For example, the shell can be removed by dissolution or by burning out. In a preferred variant of the process according to the invention, step c) simultaneously comprises calcination of the wall material, preferably at temperatures above 200° C., particularly preferably above 400° C.

If the shell in the core/shell particles is built up from a UV radiation-degradable material, preferably a UV-degradable organic polymer, the shell is removed by UV irradiation.

The cavities of the mouldings can be impregnated with liquid or gaseous materials. The impregnation here can consist, for example, in inclusion of liquid crystals, as described, for example, in Ozaki et al., Adv. Mater. 2002, 14, 514 and Sato et al., J. Am. Chem. Soc. 2002, 124, 10950.

Through impregnation with these or other materials, the optical, electrical, acoustic and mechanical properties can also be influenced—in addition to the cores, which are preferably switchable in accordance with the invention—via these liquid crystals by external energy fields. In particular, it is possible to use an external energy field to render these properties switchable in that removal of the field causes the system to exhibit different properties than in an applied field.

Locally addressable selection with the aid of the external field enables electro-optical devices to be produced in this way. The present invention therefore furthermore relates to the use of the mouldings according to the invention having homogeneous, regularly arranged cavities for the production of electro-optical devices and to electro-optical devices containing the mouldings according to the invention.

Electro-optical devices based on liquid crystals are extremely well known to the person skilled in the art and can be based on various effects. Examples of such devices are cells having dynamic scattering, DAP (deformation of aligned phases) cells, guest/host cells, TN cells having a twisted nematic structure, STN (supertwisted nematic) cells, SBE (superbirefringence effect) cells and OMI (optical mode interference) cells. The commonest display devices are based on the Schadt-Helfrich effect and have a twisted nematic structure.

The corresponding liquid-crystal materials must have good chemical and thermal stability and good stability to electric fields and electromagnetic radiation. Furthermore, the liquid-crystal materials should have low viscosity and produce short addressing times, low threshold voltages and high contrast in the cells.

They should furthermore have a suitable mesophase, for example a nematic or cholesteric mesophase for the above-mentioned cells, at the usual operating temperatures, i.e. in the broadest possible range above and below room temperature. Since liquid crystals are generally used as mixtures of a plurality of components, it is important that the components are readily miscible with one another. Further properties, such as the electrical conductivity, the dielectric anisotropy and the optical anisotropy, have to satisfy various requirements depending on the cell type and area of application. For example, materials for cells having a twisted nematic structure should have positive dielectric anisotropy and low electrical conductivity.

For example, for matrix liquid-crystal displays with integrated non-linear elements for switching individual pixels (MLC displays), media having large positive dielectric anisotropy, relatively low birefringence, broad nematic phases, very high specific resistance, good UV and temperature stability and low vapour pressure are desired.

Matrix liquid-crystal displays of this type are known. Non-linear elements which can be used for individual switching of the individual pixels are, for example, active elements (i.e. transistors). The term “active matrix” is then used, where a distinction can be made between two types:
1. MOS (metal oxide semiconductor) or other diodes on a silicon wafer as substrate.
2. Thin-film transistors (TFTs) on a glass plate as substrate.

The use of single-crystal silicon as substrate material restricts the display size, since even modular assembly of various part-displays results in problems at the joints.

In the case of the more promising type 2, which is preferred, the electro-optical effect used is usually the TN effect. A distinction is made between two technologies: TFTs comprising compound semiconductors, such as, for example, CdSe, or TFTs based on polycrystalline or amorphous silicon. Intensive work is being carried out worldwide on the latter technology.

The TFT matrix is applied to the inside of one glass plate of the display, while the other glass plate carries the transparent counterelectrode on its inside. Compared with the size of the pixel electrode, the TFT is very small and has virtually no adverse effect on the image. This technology can also be extended to fully colour-capable displays, in which a mosaic of red, green and blue filters is arranged in such a way that a filter element is opposite each switchable pixel.

The TFT displays usually operate as TN cells with crossed polarisers in transmission and are back-lit.

The term MLC displays here covers any matrix display with integrated non-linear elements, i.e., besides the active matrix, also displays with passive elements, such as varistors or diodes (MIM=metal-insulator-metal).

MLC displays of this type are particularly suitable for TV applications (for example pocket TVs) or for high-information displays for computer applications (laptops) and in automobile or aircraft construction. With decreasing resistance, the contrast of an MLC display deteriorates, and the problem of after-image elimination may occur. Since the specific resistance of the liquid-crystal mixture generally drops over the life of an MLC display owing to interaction with the interior surfaces of the display, a high (initial) resistance is very important in order to achieve acceptable service lives.

In the case of supertwisted (STN) cells, media are desired which enable greater multiplexability and/or lower threshold voltages and/or broader nematic phase ranges (in particular at low temperatures). To this end, a further widening of the available parameter latitude (clearing point, smectic-nematic transition or melting point, viscosity, dielectric parameters, elastic parameters) is urgently desired.

The mouldings according to the invention can in principle, on combination with liquid-crystal mixtures suitable in each case which are known to the person skilled in the art, be employed in electro-optical displays based on all principles described, in particular for MLC, IPS, TN or STN displays.

The mouldings having homogeneous, regularly arranged cavities obtainable in accordance with the invention are suitable firstly for the above-described use as photonic material, preferably with the impregnation mentioned, but secondly also for the production of porous surfaces, membranes, separators, filters and porous supports. These materials can also be used, for example, as fluidised beds in fluidised-bed reactors.

The following examples are intended to explain the invention in greater detail without limiting it.

### EXAMPLES

Abbreviations:

| | |
|---|---|
| ALMA | allyl methacrylate |
| CHMA | cyclohexyl methacrylate |
| KOH | potassium hydroxide |
| SDS | sodium dodecylsulfate |
| MMA | methyl methacrylate |
| MPS | methacryloxypropyltrimethoxysilane |
| PCHMA | poly(cyclohexyl methacrylate) |
| PMMA | poly(methyl methacrylate) |
| PS | polystyrene |
| PTBMA | poly(tert-butyl methacrylate) |
| SPS | sodium peroxodisulfate |
| TEOS | tetraethyl orthosilicate |
| TBMA | tert-butyl methacrylate |

Monomers and Chemicals:

KOH, SPS, SDS, TEOS, sodium bisulfite, sodium peroxodisulfate, ammonia solution 25% (all VWR), Triton X405 (Fluka) and MPS (Dynasilan™ MEMO, Degussa) are used as obtained. ALMA (Degussa) is destabilised using Dehibit™ 100 (Polyscience). Styrene (BASF) and CHMA (Degussa) are distilled under reduced pressure. MMA (BASF) was washed by shaking with 1N sodium hydroxide solution, washed with water until neutral and dried over sodium sulfate. The water content of the technical-grade absolute ethanol (Mundo) is determined by Karl Fischer titration as 0.14% by weight.

### Example 1

### Production of SiO₂ Cores

The SiO₂ cores are produced by hydrolysis and condensation of TEOS in a solution of water, ammonia and ethanol by a modified Stöber process. Firstly, seed particles are produced and subsequently enlarged in a step process. In order to synthesise the seed particles, 500 ml of ethanol and 25 ml of ammonia solution (25% by weight) are initially introduced into a 2 l round-bottomed flask with water bath, magnetic stirrer and pressure equalisation. When the reaction temperature of 35° C. has been reached, 19 ml of TEOS are injected rapidly. After stirring for 2.5 hours, the particles are enlarged by addition of 4 ml of ammonia solution and injection of 15 ml of TEOS. In order to complete the reaction, the mixture is stirred for a further 4 hours. The suspension formed comprises 0.69M NH₃, 2M H₂O and 2.5% by weight of SiO₂.

The seed particles are enlarged stepwise. To this end, the suspension is diluted with ethanol and ammonia solution in such a way that the concentration of SiO₂ is 0.5% by weight before each reaction step and 2.5% by weight after the reaction step. The concentrations of ammonia and water are kept constant at 0.69M NH₃ and 2M H₂O. For example, 265 ml of SiO₂ suspension are initially introduced into a 2 l round-bottomed flask with water bath, magnetic stirrer and pressure equalisation and diluted with 165.5 ml of ethanol and 9.5 ml of ammonia solution (25% by weight). When the reaction temperature of 35° C. has been reached, 13 ml of TEOS are injected rapidly. In order to complete the reaction, the mixture is stirred for at least 4 hours. The next reaction step can be carried out directly thereafter or after cooling and storage of the suspension for a number of days.

Analysis of the particle diameters by TEM gives the following correlations:

| Dry colour | Mean diameter | Standard deviation |
|---|---|---|
| Pale violet | 143 nm | 5.6% |
| Violet | 184 nm | 4.9% |
| Blue-green | 218 nm | 4.2% |
| Yellow-green | 270 nm | 4% |

### Example 2

### Functionalisation of the SiO₂ Cores

3 ml of MPS dissolved in ethanol are added with stirring at room temperature to 1.3 l of ethanolic suspension comprising 2.5% by weight of SiO₂ (SiO₂ suspension having a violet dry colour (wavelength maximum I 111=400 nm, mean particle diameter according to TEM 201 nm; according to Example 1)), 0.69M NH₃ and 2M H₂O. The mixture is firstly warmed slowly to 65° C. under atmospheric pressure in a rotary evaporator. After 1.5 hours, distillation of an azeotropic mixture of ethanol and water is commenced by reducing the pressure. The liquid distilled off is replaced with absolute ethanol. In total, 1.2 l of ethanol/water mixture are removed. After 2 hours, the reaction solution is concentrated to 300 ml and transferred into a 1 l round-bottomed flask. 0.06 g of SDS, dissolved in 120 g of water, is added, and ethanol is again distilled off at 65° C. The liquid distilled off is replaced with water.

The other samples from Example 1 are reacted analogously.

### Example 3

### Emulsion Polymerisation

The emulsion polymerisation is carried out in a double-walled, 250 ml glass reactor thermostatted at 75° C. and fitted with inert-gas inlet, propeller stirrer and reflux condenser. Argon is bubbled through 89 g (comprising 17 g of SiO₂) of SiO₂ suspension as described in Example 2 for 20 minutes. 0.02 g of SDS in 23 g of water is then added, and the mixture is introduced into the reactor. 0.05 g of SPS, dissolved in 3 g of water, is subsequently added. After 15 minutes, a monomer emulsion of 39 g of MMA, 3.9 g of ALMA, 0.12 g of SDS, 0.05 g of KOH and 80 g of water is metered in continuously over a period of 400 minutes. The reactor contents are stirred for 60 minutes without further addition.

The core/shell particles can subsequently be precipitated in ethanol, the precipitation can be completed by addition of concentrated aqueous sodium chloride solution, distilled water can be added to the suspension, the mixture can be filtered through a suction filter, and the polymer can be dried at 50° C. under reduced pressure.

### Example 4

### Inversion

Glass specimen slides are degreased using surfactant solution, stored in concentrated KOH for 24 hours and rinsed thoroughly with demineralised water. They are then immobilised vertically in 30 ml beakers. 25 ml of the latex from Example 3 (the precipitation described as optional in Example 3 is omitted here) diluted with water to a solids content of 0.2-0.4% by weight are subsequently introduced, and the arrangements are dried for three days at 55° C. In order to accelerate the drying, a slow stream of air is passed through the oven. During drying of the latex, colloidal/crystalline layers of closest packed latex particles form on the specimen slides. For inversion with SiO₂, a solution of 5.6 g of TEOS, 3.2 g of ethanol, 3 g of water and 1.2 g of concentrated hydrochloric acid is sprayed on after the end of the drying, and the samples are stored overnight in a fume cupboard for hydrolysis, during which SiO₂ forms in the cavities of the colloidal/crystalline layers. The formation of SiO₂ is then completed by heating at 450° C. for two hours under an air atmosphere, and at the same time the polymer PMMA is removed from the structure.

### Example 4a

### Inversion to Give TiO₂

The inversion with TiO₂ is carried out in the same way. To this end, a solution of 4 g of ethanol, 1.2 g of concentrated hydrochloric acid, 3 g of titanium tetrachloride and 8 g of water is used.

The resultant inverted structures are white and opaque, and the sample having the TiO₂ wall structure exhibits strong, angle-dependent reflection colours after infiltration with isopropanol.

### Example 5

### Magnetic Cores

700 g of monodisperse SiO₂ particles (produced analogously to Example 1; “Monospher”) having a mean particle diameter of 500 nm are stirred into 1500 g of deionised water, and the mixture is dispersed for one hour using an Ultra-Turrax. The dispersion is subsequently adjusted to an SiO₂ content of 5% using 11,800 g of deionised water, and the temperature is adjusted to 20° C. 210 g of iron(II) sulfate heptahydrate (Article No. 1.03965; Merck KGaA) and 380 g of iron(II) sulfate hydrate 80% (Article No. 3926; Merck KGaA) are dissolved in 4500 g of deionised water with stirring and introduced into a sealable storage vessel. Furthermore, a 10% aqueous ammonia solution is transferred into a sealed storage vessel in order to maintain the pH. The iron sulfate solution is then metered over the course of 2 hours into the Monospher dispersion held at 20° C., with the pH being adjusted to 7.7 by simultaneous addition of the ammonia solution. After post-reaction for half an hour, the SiO₂ coating is begun. 350 g of tetraethylorthosilane are dissolved in a mixture of 290 g of glacial acetic acid and 2275 g of deionised water over the course of 30 minutes with stirring in a sealed apparatus. The resultant solution is metered into the dispersion at a rate of 120 ml/min. The pH is then raised to 9.0 over the course of 30 min. using the aqueous ammonia solution, and the dispersion is warmed to 75° C. and held at this value for 30 min. After cooling to room temperature, the dispersion is worked up. Over the course of 8 hours, the dispersion is washed five times with 6 l of deionised water by decantation, with the sedimentation rate of the magnetic particles being accelerated by application of a magnetic field. The resultant dispersion is adjusted to a solids content of 20%. The further processing is carried out analogously to Examples 2 to 4.

### Example 6

### Production of a Template Film

Dried, pulverulent polymers according to Example 3 are granulated at 200° C. in an extruder (DSM Research microextruder). The granules are heated in a hydraulic press (Collin 300 P) and pressed at a pre-specified hydraulic pressure. The mould used comprises flat, PET film-covered metal plates. A typical pressing programme for the production of films having a diameter of about 10 cm and a thickness of about 0.15 mm is:

initial weight 2-3 g of polymer;

preheating for 5 minutes at 180° C., without pressure;

pressing for 3 minutes at a hydraulic pressure of 1 bar at 180° C.;

pressing for 3 minutes at a hydraulic pressure of 150 bar at 180° C.;

slow cooling for 10 minutes at a hydraulic pressure of 150 bar, reaching about 90° C.;

rapid cooling to room temperature, without pressure.

### INDEX OF THE FIGURES

FIG. 1:

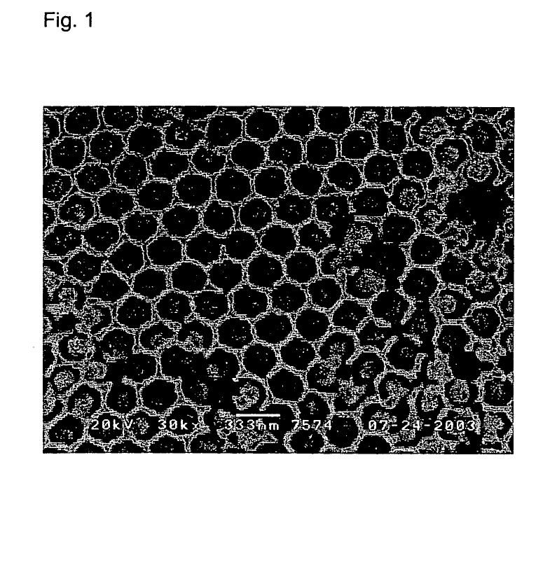

Scanning electron photomicrograph (SEM photograph) of the surface of a sample from Example 4. The regularly arranged cavities and the particles present therein are evident.

FIG. 2:

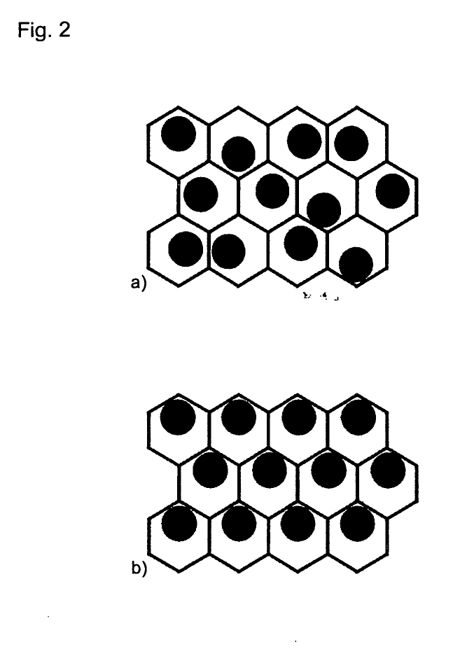

Diagrammatic representations of the honeycomb structure of the inverse opal with included core particles. Each cavity contains precisely one core particle. In FIG. 2a), the core particles are arranged irregularly in the cavities. The crystalline symmetry of the inverse opal is destroyed. A sample of this type appears white and opaque in light due to diffuse scattering. In FIG. 2b), the core particles are aligned homogeneously in the cavities. A colloidal/crystalline lattice is present, meaning that colour effects occur.

1. Use of core/shell particles whose shell forms a matrix and whose core is essentially solid, is built up essentially from an inorganic material and has an essentially monodisperse size distribution and is connected to the shell via an interlayer, for the production of mouldings having homogeneous, regularly arranged cavities and particles in the cavities.

2. Use according to claim 1, characterised in that the core consists of an electrically and/or magnetically conductive material or has an electrically and/or magnetically conductive layer or has an electrically and/or magnetically conductive core, where the electrically and/or magnetically conductive material is preferably a metal or magnetite.

3. Use according to claim 1, characterised in that the core in the core/shell particles makes up from 10⁻⁵% by vol. to about 75% by vol. of the core/shell particle volume, preferably from 10⁻⁴% by vol. to 60% by vol. and particularly preferably from about 10⁻³% by vol. to about 50% by vol. of the core/shell particle volume.

4. Use according to claim 1, characterised in that the shell in the core/shell particles consists of essentially uncrosslinked organic polymers which are grafted onto the core via an at least partially crosslinked interlayer, where the shell preferably comprises from poly(styrene), poly(acrylate) derivatives, particularly preferably poly(methyl methacrylate) or poly(cyclohexyl methacrylate), or copolymers of these polymers with other acrylates, such as, preferably, styrene-acrylonitrile copolymers, styrene-ethyl acrylate copolymers or methyl methacrylate-ethyl acrylate copolymers, and the interlayer is preferably built up from methyl methacrylate-allyl methacrylate copolymers.

5. Use according to claim 1, characterised in that the shell in the core/shell particles is essentially built up from a UV radiation-degradable material, preferably a UV-degradable organic polymer and particularly preferably from poly(tert-butyl methacrylate), poly(methyl methacrylate), poly(n-butyl methacrylate) or copolymers containing one of these polymers.

6. Use according to claim 1, characterised in that the core in the core/shell particles comprises a metal or semimetal or a metal chalcogenide or metal pnictide, particularly preferably silicon dioxide or titanium dioxide.

7. Use according to claim 1, characterised in that the core/shell particles have a mean particle diameter in the range about 50-800 nm, preferably in the range 100-600 nm and particularly preferably in the range from 200 to 450 nm.

8. Use according to claim 1, characterised in that the cores have a surface modification, preferably with silanes carrying reactive end groups, such as epoxy functions or free double bonds.

9. Use according to claim 1, characterised in that the mouldings are films.

10. Process for the production of mouldings having homogeneous, regularly arranged cavities and particles in the cavities, characterised in that
a) core/shell particles whose core is essentially solid, is built up essentially from an inorganic material and has an essentially monodisperse size distribution and is connected to the shell via an interlayer, are converted into mouldings, preferably films, with application of a mechanical force and elevated temperature,
b) one or more precursors of suitable wall materials are added,
c) and the shell material is subsequently removed.

11. Process for the production of mouldings having homogeneous, regularly arranged cavities and particles in the cavities according to claim 10, characterised in that the application of a mechanical force takes place in a step a2) to a mass of the core/shell particles pre-dried in step a1).

12. Process for the production of mouldings having homogeneous, regularly arranged cavities and particles in the cavities according to claim 11, characterised in that the application of a mechanical force takes place through uniaxial pressing or during an injection-moulding operation or during a transfer moulding operation or during (co)extrusion or during a calendering operation or during a blowing operation.

13. Process according to claim 1, characterised in that the core/shell particles are cooled under the action of the mechanical force to a temperature at which the shell is no longer flowable.

14. Process for the production of mouldings having homogeneous, regularly arranged cavities and particles in the cavities according to claim 1, characterised in that the precursor in step b) is a solution of an ester of an inorganic ortho-acid with a lower alcohol.

15. Process for the production of mouldings having homogeneous, regularly arranged cavities and particles in the cavities according to claim 1, characterised in that step b) is carried out under reduced pressure, preferably in a static vacuum where p<1 mbar.

16. Process for the production of mouldings having homogeneous, regularly arranged cavities and particles in the cavities according to claim 1, characterised in that step c) comprises a calcination, preferably at temperatures above 200° C., particularly preferably above 400° C.

17. Process according to claim 10, characterised in that the shell is removed by UV irradiation.

18. Mouldings having homogeneous, regularly arranged cavities, characterised in that the regularly arranged cavities essentially each contain one particle.

19. Mouldings according to claim 18, characterised in that the particles consist of an electrically and/or magnetically conductive material or have an electrically and/or magnetically conductive layer or have an electrically and/or magnetically conductive core, where the electrically and/or magnetically conductive material is preferably a metal or magnetite.

20. Mouldings according to claim 1, characterised in that the cavities have a mean diameter in the range about 50-500 nm, preferably in the range 100-500 nm and very particularly preferably in the range from 200 to 280 nm.

21. Mouldings according to claim 18, characterised in that the cavities are embedded in a matrix which preferably essentially comprises a metal chalcogenide or metal pnictide, particularly preferably silicon dioxide, titanium dioxide and/or aluminium oxide.

22. Use of mouldings according to claim 18 as photonic material.

23. Use of mouldings according to claim 18 for the production of electro-optical devices.

24. Electro-optical device containing mouldings according to claim 18.
